(19) United States
(12) Patent Application Publication
(10) Pub. No.: US 2021/0292590 A1
(43) Pub. Date: Sep. 23, 2021

(54) Moisture, Grease, and Oil Resistant Coatings for Cellulosic Materials

(71) Applicant: World Centric, Rohnert Park, CA (US)

(72) Inventors: Xing JIN, Albany, CA (US); Randal SHOGREN, Columbia Falls, MT (US)

(21) Appl. No.: 17/204,375

(22) Filed: Mar. 17, 2021

Related U.S. Application Data
(60) Provisional application No. 62/990,777, filed on Mar. 17, 2020.

(51) Int. Cl. C09D 103/02; C09D 103/12; B05D 3/02; B05D 1/28; B05D 1/02; B05D 1/18; B05D 7/24; A47G 19/03; D21H 19/12; D21H 11/12; D21H 27/10

(52) U.S. Cl. CPC C09D 103/02; C09D 103/12; B05D 3/0272; B05D 1/28; B05D 1/02; D21H 27/10; B05D 7/24; A47G 19/03; D21H 19/12; D21H 11/12; B05D 1/18

(57) ABSTRACT

A coated cellulose-based food or beverage container that is resistant to penetration by oil and grease in the presence of water. The container may be coated with a starch dispersion that includes a starch having an amylose content of 20% by weight to 100% by weight (e.g., 30% by weight to 50% by weight). Methods for producing the coated container include preparing a starch suspension, heating the starch suspension to form a starch dispersion, applying the heated starch dispersion to the container to form a coating, and drying the coating.

### CROSS-REFERENCE

This application claims the benefit of U.S. Provisional Application No. 62/990,777, filed Mar. 17, 2020, which is incorporated herein in its entirety by reference thereto.

### BACKGROUND

The described embodiments relate generally to coatings for cellulose-based products that are resistant to penetration by oil and grease even in the presence of water. The cellulose-based products may include food and beverage containers.

### BRIEF SUMMARY

Some embodiments are directed to a container for a food or a beverage that comprises a substrate, the substrate comprising cellulose; a biodegradable coating on a first surface of the container, wherein the coating comprises a starch, and wherein the starch comprises at least 20% by weight amylose, and wherein the coating is resistant to penetration by oil and grease in the presence of water for at least 1 hour.

In any of the various embodiments discussed herein, the substrate comprises at least 30% cellulose. In any of the various embodiments discussed herein, the starch has 30% to 50% by weight amylose. In any of the various embodiments discussed herein, the container is a single-use container. In any of the various embodiments discussed herein, the container is compostable. In any of the various embodiments discussed herein, the first surface is an interior of the container. In any of the various embodiments discussed herein, the coating is a continuous layer on an interior of the container.

In any of the various embodiments discussed herein, the starch coating is on a second surface of the container, and the second surface is an exterior of the container, and the starch coating on the exterior of the container is the same as the starch coating on the interior of the container.

In any of the various embodiments discussed herein, the starch comprises at least one of pea starch, bean starch, high amylose corn starch, high amylose wheat starch, high amylose potato starch, or high amylose barley starch. In any of the various embodiments discussed herein, the starch is an unmodified starch. In any of the various embodiments discussed herein, the cellulose is derived from at least one of wheat straw, sugarcane bagasse, or bamboo.

In any of the various embodiments discussed herein, the cellulose-fiber matrix comprises alkyl ketene dimer, and the alkyl ketene dimer is present in an amount of greater than 0% by weight and less than or equal to 1% by weight.

In any of the various embodiments discussed herein, the coating has a dried coat weight of about 1% to about 15% (e.g., about 1% to about 5%) of a weight of the substrate. In any of the various embodiments discussed herein, the coating has a dried coat weight of about 3 g/m² to about 60 g/m² (e.g., about 5 g/m² to about 25 g/m²).

Some embodiments are directed to a method of preparing a coated container for a food or beverage, the method comprising molding a substrate to form a container, the substrate comprising cellulose; applying an aqueous dispersion to a first surface of the container to form a biodegradable coating, the aqueous dispersion comprising a starch, and wherein the starch comprises at least 20% by weight amylose, drying the coated container at a temperature of 80° C. to 200° C. for a period of time, wherein the coating is resistant to penetration by oil and grease in the presence of water.

In any of the various embodiments discussed herein, the container comprises at least 30% cellulose. In any of the various embodiments discussed herein, the starch has an amylose content of 30% to 50% by weight amylose.

In any of the various embodiments discussed herein, the method further comprises cooling the coated container at a temperature of 10° C. to 50° C. for 1 minute to 60 minutes (e.g., 1 minute to 10 minutes) before drying. In any of the various embodiments discussed herein, the cooling is done at a temperature of 20° C. to 30° C.

In any of the various embodiments discussed herein, the drying is done at a temperature of 100° C. to 150° C. In any of the various embodiments discussed herein, the drying is done for 1 minute to 60 minutes. In any of the various embodiments discussed herein, the drying is done for 1 minute to 5 minutes. In any of the various embodiments discussed herein, the first surface is either an interior of the container or an exterior of the container.

Some embodiments are directed to a method of preparing a coating for a single-use food or beverage container, the method comprising mixing a starch having at least 20% by weight amylose with water to form a suspension; heating the suspension to a temperature of greater than 60° C. (e.g., 80° C. to 160° C.); and agitating the suspension. In any of the various embodiments discussed herein, the starch has an amylose content of 20% to 100% (e.g., 30% to 50%) and the suspension is heated a temperature of about 80° C. to about 100° C. In any of the various embodiments discussed herein, the starch has an amylose content of greater than 50% and the suspension is heated to a temperature of about 120° C. to about 160° C. In any of the various embodiments discussed herein, heating and agitating are each continuous for a period of time to produce the coating. In any of the various embodiments discussed herein, the coating has a viscosity of 10 centipoise to 2000 centipoise. In any of the various embodiments discussed herein, the finished dried coating is resistant to penetration by oil and grease even in the presence of water.

In any of the various embodiments discussed herein, the heating occurs simultaneously with the agitating. In any of the various embodiments discussed herein, the coating has a viscosity of 1000 centipoise to 10,000 centipoise. In any of the various embodiments discussed herein, the method further comprises applying the coating to the container. In any of the various embodiments discussed herein, the coating may be applied to only an interior of the container, to only an exterior of the container, or to both an interior of the container and an exterior of the container.

### BRIEF DESCRIPTION OF THE DRAWINGS

FIG. 1 shows a container according to some embodiments.

FIG. 2 shows a container according to some embodiments.

FIG. 3 shows a container according to some embodiments.

FIGS. 4A-4E show an exemplary process of applying the coating.

FIG. 5 shows a flow chart of a method according to some embodiments.

### DETAILED DESCRIPTION

Plastic is widely used in many single-use applications, including in food and beverage applications. For example, many cups, plates, containers, and wraps are made of single-use plastic. Single-use plastic packaging made from petroleum-derived polymers (e.g., polystyrene and polyethylene) can raise recycling challenges, and the availability of resources for making these products may be inconsistent or declining. Many petroleum-derived polymers require a significant amount of time to degrade. And the use of these types of polymers in single-use plastic packaging can increase likelihood that such packaging (and the constituent polymers) are not disposed of properly may persist in the environment. Furthermore, these types of polymers may accumulate in animals and people that interact with these products.

Cellulose-fiber-based packaging is sometimes used to replace single-use plastic packaging because of improved sustainability. Cellulose-based packaging or product may include any packaging made of cellulose fibers or a cellulose-fiber matrix. For example, compared to similar plastic packaging, cellulose-based products are more sustainable because they can be produced from renewable resources (e.g., renewable crops) and have improved biodegradability and compostability. Although cellulose-based products have become increasingly popular, cellulose-based food and beverage packaging are less resistant to penetration by oils, greases, water, moisture, or steam when compared to similar plastic-based packaging. This can be problematic in the food and beverage industry as grease, oil, and water are present in nearly every application and can seep through the cellulose-based packaging and onto clothes, hands, or other surfaces. Aside from being messy, this can also weaken the structural integrity of the packaging and make it more likely that the packaging fails.

Existing cellulose-based food and beverage containers are often coated with materials such as polyethylene, petroleum waxes, acrylics, poly(ethylene-co-vinyl alcohol), polyvinyldene chloride, and polyfluoroalkyl substances (PFAS), among others. But none of these coating materials are biodegradable according to broadly accept standards, such as those set by the American Society for Testing Methods (“ASTM”). For example, estimated biodegradation rates for many of these materials is hundreds of years. Further, it can be challenging to recycle cellulose-based packaging with these coatings because of the bonds between the polymers and substrate.

Existing methods may also include, for example, surface lamination of cellulose-based products with a thin plastic film. But biodegradable plastic lamination generally increases material costs to a point at which their use is not commercially viable for single-use packaging. And conventional plastic lamination is not biodegradable and generally disqualifies products from composting after use. To pass certification for composting, any non-biodegradable and non-inert chemical in cellulose-based products must be less than 1 weight percent of the product. Conventional coatings of non-biodegradable polymers are subject to this limit, and this required weight percent is too low for effective resistance to penetration by oils.

Accordingly, there is a need for cellulose-based food and beverage packaging that is fully compostable, fully biodegradable, and resistant to penetration by oils and greases even in the presence of water or moisture. Such packaging may be safer, created from more renewable materials, and may be disposed of in a more environmentally friendly matter. Additionally, the benefits of such packaging will improve the overall consumer experience.

Starch provides many benefits for use in single-use articles because it is biodegradable, abundant, and inexpensive. For example, starch can be refined from many types of renewable crops, such as corn, wheat, potatoes, cassava, rice, and beans. And unmodified starches can have costs comparable to or even less than the typical prices for commodity plastics (e.g., polyethylene, polypropylene, polystyrene) and as little as 10% of the typical prices for specialty resins (e.g., acrylic emulsions). Chemically modified starches have been used in the food, textile and paper industry. But these articles incorporating such existing starches are prone to failure if exposed to heat or water. For example, existing starch coatings may be disrupted or even dissolve when exposed to warm water. If the coating dissolves, then any benefit related to oil or grease resistance is also eliminated.

Starches have an abundance of hydroxyl groups and strong hydrogen bonding, which makes starch a good barrier to non-polar compounds (e.g., lipids, oxygen, and other organics) in the dry state. Starches may be used to prepare grease or oil resistant papers. However, typical starches can be easily destroyed or dissolved by polar molecules (e.g., water) which can eliminate the grease or oil-resistance of these starches. This makes such starches of limited use in applications involving food that is moist or any beverages. To combat this, existing methods sometimes add reactive cross-linking chemicals. However, most cross-linking chemicals are toxic, which makes them unsuitable for food contact.

Attempts have been made to modify starch while maintaining biodegradability by chemically modifying starch compositions using fully biodegradable polyester blends. But these applications are expensive and may be cost-prohibitive for use in single-use cellulose-based products.

Starch is composed of amylose and amylopectin. Amylose is a mostly linear component, and amylopectin is a highly branched component. As amylose content increases, the tensile strength and elongation at break of starch films increase.

There have been major challenges related to coating paper products with heated neat-amylose solution. As used herein, “neat amylose” refers to pure or 100% amylose. It is difficult to form continuous coatings because of the rapid gelation of the amylose before a smoothed continuous coating can be formed. To minimize unwanted gelation, coatings may be applied to paper rolls at high speeds. In some methods, a smoothing operation almost immediately follows application of a hot aqueous solution of amylosic material to the paper web with a roll applicator. However, these coating methods only work for flat paper sheets. And these methods are not suitable for coating rigid or contoured objects like single-use cellulose-based containers (e.g., molded cups, plates, or clamshells) because they are not flat or as flexible as paper sheets. Due to fast drying on heated rolls typically used in paper machines these methods dry the coating on the paper sheets within seconds. Such rapid drying results in coatings with low crystallinity and poor water resistance. This is because drying high amylose starch solutions rapidly (i.e., within seconds) using equipment such as a drum dryer or spray dryer gives an amorphous structure, and such obtained solids are readily dispersible in water. In contrast, the starch coatings according to the present disclosure have considerable water resistance. Without being bound by theories, this improved water resistance is believed to be due to crystallization occurring over the relatively much longer drying and optional cooling times employed (i.e., several minutes).

The present inventors have found that it is possible to prepare a single-use cellulose-based container that is fully biodegradable and resistant to penetration by oil and grease in the presence of water. Specifically, using a starch dispersion made of a mixture of hot water and starches with intermediate to high amylose content, it is possible to coat a cellulose-based substrate using conventional coating processes in convention settings and obtaining a coating that is resistant to oil and grease in the presence of water. The coating, when dried, is resistant to penetration by oil and grease in the presence of water. These starches may have an amylose content in the range of about 20% by weight to about 99% by weight (e.g., about 30% by weight to about 50% by weight). Gelation of dispersions of starches containing about 30% to about 50% amylose on cooling is slow enough that convenient coating methods such as spraying or brushing become feasible. As demonstrated in the examples below, a dispersion of starch comprising about 70% amylose can be applied by a simple dipping process (i.e., there is no need for more-restrictive process requirements).

As disclosed herein, applications that use a starch-based coating that has a moderate to high level of amylose content show improved resistance to penetration by oil and grease in the presence of water, even when the water exposure for extended periods of time. For example, single-use cellulose-based food and beverage packaging that is coated with such moderate to high amylose starch may be resistant to oil and grease penetration in the presence of water for several hours or up to several days (e.g., 1 or more days, 2 or more days, or 3 or more days), which is much longer than the typical use time of single-use food and beverage packaging. Additionally, these products may be fully biodegradable and fully compostable.

Starches may be in various forms, including unmodified, native, granular, pregelatinized, or chemically modified (degree of substitution<0.05). Chemical modification may ease dissolution in water but slow gelation on cooling, which may reduce crystallization. Chemical modification may include modification using hydroxypropylation, acetylation, phosphorylation and alkenylsuccinylation. In some embodiments, the starch is unmodified. Starches having an amylose content of 20% by weight to 100% by weight may be used. In some embodiments, starches having amylose content of 30% by weight to 50% by weight are used. In some embodiments, multiple starches may be mixed to achieve a desired amylose content. For example, starches with less than 30% by weight amylose content or more than 50% by weight amylose content may be mixed to form a mixture of starch having a total amylose content of between 30% by weight and 50% by weight. To achieve any desired amylose content, one or more starches may be mixed. For example, to achieve an amylose content of about 30% by weight to about 50% by weight, starches having less than 30% by weight amylose (e.g., 20% by weight to 30% by weight) may be mixed with the high amylose starches listed below in concentrations of 1% to 20%. Examples of these starches may include corn, waxy corn, wheat, rice, and potato. Any suitable mixture of starches may be used to achieve an amylose content of 20% by weight to 100% by weight. Such mixtures do not adversely affect barrier properties of the coating as long as the total amylose content is greater than 20% by weight (e.g., 30% by weight to 50% by weight).

Starches that may be used include those having at least 20% by weight amylose content (e.g., 20% by weight to 100% by weight, 30% by weight to 90% by weight, 30% by weight to 80% by weight, 30% by weight to 70% by weight, 30% by weight to 60% by weight, 30% by weight to 50% by weight, or 30% by weight to 40% by weight). Examples include legume starches (e.g., pea starch, bean starch, mung bean starch), cereal starches (e.g., high amylose corn, high amylose wheat, high amylose barley), and tuber starches (e.g., high amylose potato). In some embodiments, corn, wheat, potato, and rice starches are used that have amylose content of 20% by weight to 30% by weight (e.g., about 25%). In some embodiments, pea and bean starches have amylose content of 30% by weight to 50% by weight. In some embodiments, high amylose corn starch has an amylose content of 50% by weight to 90% by weight. Starches with an amylose content of less than 30% by weight or greater than 50% by weight may be used to provide a starch mixture with an amylose content of greater than 30% by weight amylose and less than 50% by weight.

The present inventors have found that starches with amylose content in the range of 30% by weight to 50% by weight readily form coatings that are stable when in contact with hot water, even boiling water, while also being resistant to oil and grease penetration. Additionally, it has been discovered that stable dispersion of this type of starch may be prepared at lower temperatures compared with starches having amylose content greater than 50% by weight. For example, starches (or starch mixtures) having a total amylose content greater than 50% by weight may require heating to high temperatures (e.g., between 110° C. and 140° C.) to fully gelatinize. Further, pre-gelatinization of the starch may allow for a stable dispersion to be obtained at much lower temperatures.

Crystallization and gelation rates are also important factors in producing a continuous coating that is resistant to oil and grease penetration in the presence of water penetration. Gelation may begin immediately when the starch is cooled, but crystallization takes longer. For example, crystallization of pure amylose in an aqueous solution occurs over the course of minutes to hours (e.g., 1 minute to 120 minutes), while the crystallization of pure amylopectin occurs over the course of several days to weeks (e.g., 3 days to 2 weeks). Low amylose crystallinity may correspond to less coating stability in the presence of water. As starch concentration increases, crystallization rates and gelation rates increase. This can increase viscosity of the coating, which in turn make application of the coating more difficult. Crystallization may also occur during the oven-drying process.

Amylose content in the range of about 20% by weight to about 99% by weight (e.g., 20% by weight to 70% by weight, 20% by weight to 50% by weight, or 30% by weight to 50% by weight) may allow for easier gelatinization at lower temperatures and easier application due to slower gelling. Without being bound by theories, enhanced oil and grease resistance in the presence of water may be due to amylose double helix formation, self-association into junction zones, and eventual crystallization. Amylopectin in starches may co-crystallize with some of the amylopectin, leading to higher crystallinities than those expected based on amylose content. The overall effect of these changes is physically cross-linked starch coating that is highly impermeable and more resistant to swelling in water.

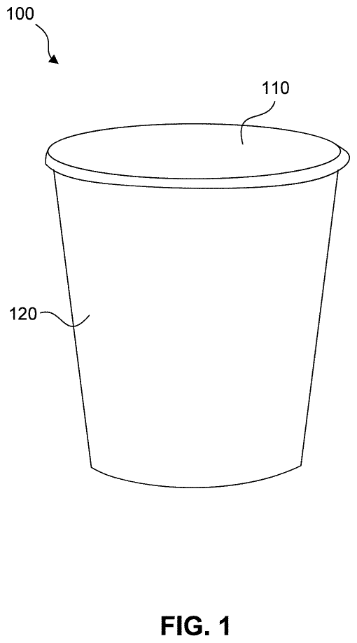

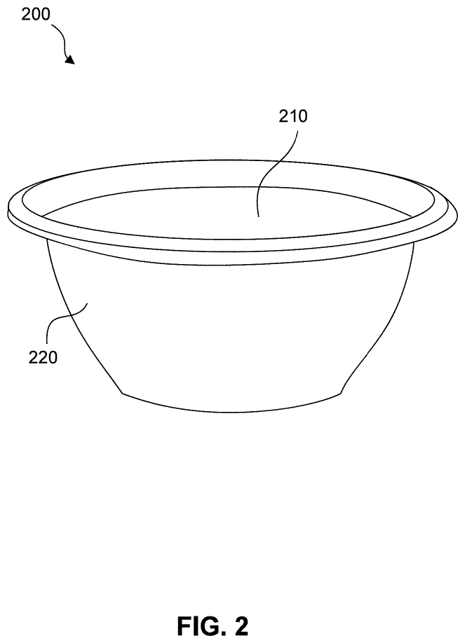

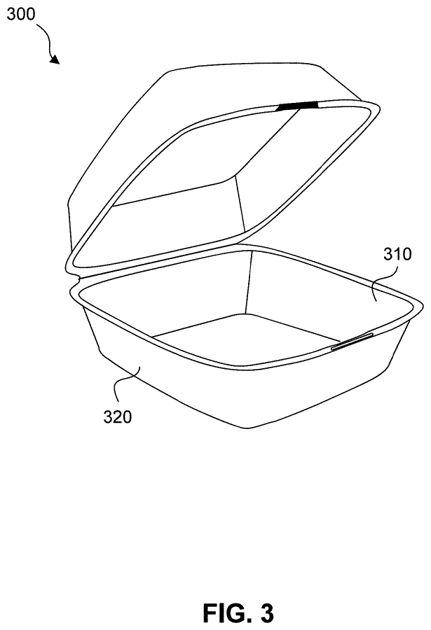

The starch dispersion may be applied as a coating to any cellulose-based substrate. In some embodiments, the cellulose-based substrate is a single-serve cellulose-based container for a food or beverage (e.g., cups, bowls, plates, clamshells). In some embodiments, the cellulose-based substrate is a flat sheet (e.g., paper or paperboard). The cellulose-based product may be produced from any suitable cellulose source, including wheat straw, sugarcane bagasse, bamboo, hardwoods, softwoods, corn stalk, flax, hemp, jute, rice straw, switchgrass, reed grass, or miscanthus (silvergrass). A non-PFAS additive in the cellulose-fiber matrix may be used with the cellulose to improve the strength of the cellulose-fiber matrix when exposed to water. In some embodiments, the non-PFAS additive is an alkyl ketene dimer that is present in an amount greater than 0% by weight to less than or equal to 3% by weight, greater than or equal to 0.1% by weight to less than or equal to 1% by weight, or greater than or equal to 2% by weight to less than or equal to 3% by weight, and all ranges and sub-ranges between the foregoing values having any two of the above-listed temperature values as endpoints, including the endpoints. In some embodiments, the concentration of the alkyl ketene dimer in the cellulose-fiber matrix is between 0% and 1%. To improve water resistance of the cellulose-fiber matrix, other internal sizing agents may also be added. For example, the internal sizing agents may be alkenyl succinic anhydride, rosin, wax, or acrylate based agents. Wet-strength agents, such as urea-formaldehyde, melamine-formaldehyde, and polyamide-epichlorohydrin, may also be added to the cellulose-fiber matrix as far as related regulations allow. FIGS. 1-3 show exemplary food or beverage containers. FIG. 1 shows an exemplary cup 100, and the coating may be applied to interior surface 110 and, optionally, to exterior surface 120. FIG. 2 shows an exemplary bowl 200, and the coating may be applied to interior surface 210 and, optionally, to exterior surface 220. FIG. 3 shows an exemplary clamshell style food container 300, and the coating may be applied to interior surface 310 and, optionally, to exterior surface 320. In some embodiments, the coating is applied to a surface that contacts food or beverage (e.g., interior surfaces 110, 210, or 310). In some embodiments, the coating is applied only to a surface that contacts food or beverage (e.g., interior surfaces 110, 210, or 310). In some embodiments, the coating is applied only to a surface that does not contact food or beverage (e.g., exterior surfaces 120, 220, or 320). The coating may be applied to any suitable food or beverage container, including plates, bowls, cups, trays, clamshells, and more closed systems such as bottles. The food or beverage container may be a single-use container, meaning it is intended to be discarded after one use. The container has an average thickness of about 0.1 millimeter to 1 millimeter. In some embodiments, the container has an average thickness of about 0.5 millimeter.

The starch dispersion may be applied to a contoured surface. The starch dispersion may be applied as a continuous coating to the contoured surface. For example, the starch dispersion may be applied to a cellulose-based food or beverage container (e.g., cup 100, bowl 200, or clamshell 300) as a continuous coating. The cellulose-based food or beverage container may be entirely biodegradable and compostable. In some embodiments, the cellulose-based food or beverage containers has a cellulose content of 50% to 100%. In some embodiments, the cellulose-based product may include at least 30% cellulose (e.g., at least 40% cellulose, at least 50% cellulose, at least 60% cellulose, at least 70% cellulose, at least 80% cellulose, at least 90% cellulose, or at least 95% cellulose). In some embodiments, the cellulose-based food or beverage container contains no plastic. In some embodiments, the cellulose-based food or beverage container is contoured and rigid. A continuous surface coating ensures that the food or beverage container is resistant to penetration by oil and grease in the presence of water. In some embodiments, the starch dispersion is applied as a continuous coating. In some embodiments, the starch dispersion is applied to an interior side of the food or beverage container (i.e., on a side of the container that contacts a food or beverage). In some embodiments, the starch dispersion is applied to an interior side and an exterior side of the food or beverage container.

The starch dispersion may be applied to flat or nearly flat surface. The starch dispersion may be applied as a continuous coating to the flat or nearly flat surface. For example, the starch dispersion may be applied to cellulose-based paper, food wraps, or paperboard sheets that may be folded to form containers.

The starch dispersion that is applied as a coating may contain only an aqueous solution of a native starch. For example, in some embodiments, the starch dispersion may be free of any emulsion or solution of synthetic polymers (e.g., acrylics such as acrylate, vinyl alcohol, styrene-butadiene), reactive cross-linking chemicals, polymer latexes, or other additives. The starch dispersion may be used to prepare a composite coating formulation. For example, various substances may be added that do not adversely affect biodegradability or the water and oil barrier properties, such as cellulose micro- and nanofibers, minerals (e.g., clays, calcium carbonate), waxes (e.g., carnauba, soy, beeswax, and paraffin), cross-linking agents (e.g., calcium, magnesium, iron, zirconium salts, and aldehydes), polyvalent carboxylic acids (e.g., adipic acid, citric acid, azelaic acid, alginic acid, and polyaspartic acid), and biodegradable polyester emulsions (e.g., polylactic acid, polyhydroxybutyrate, and polybutylene succinate). The starch coatings may be overcoated with wax emulsions, polyester dispersions or sizing agent emulsions (e.g., alkyl ketene dimer, alkenyl succinic anhydride, and monostearyl citrate) to further enhance water resistance.

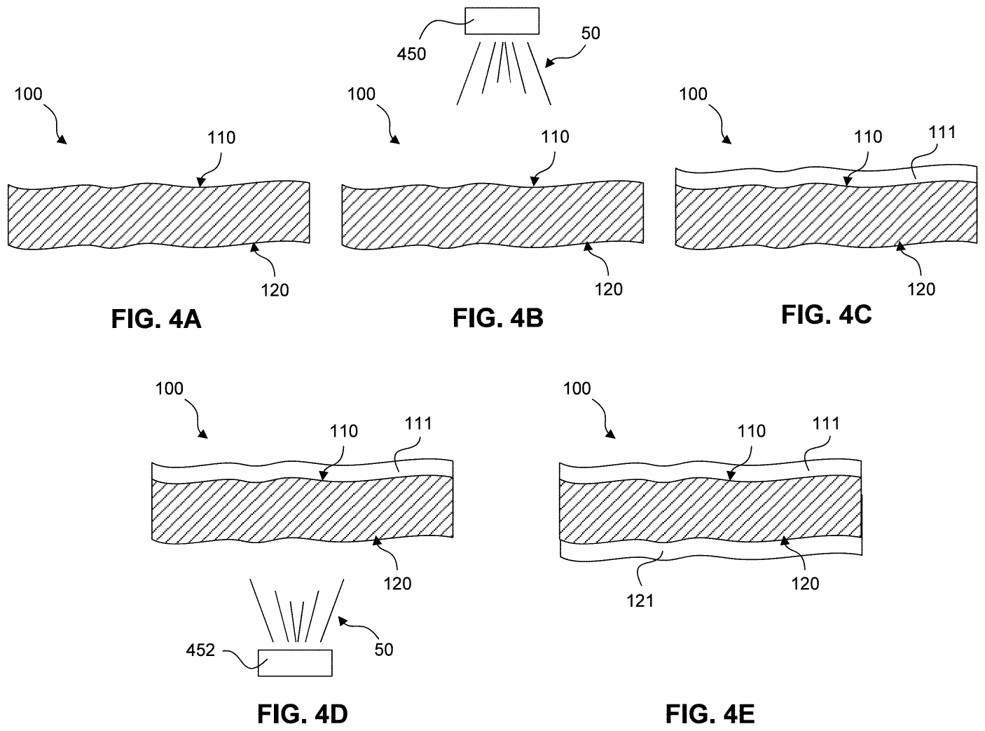

FIGS. 4A-4E illustrate an exemplary process of applying the coating. FIG. 4A shows a cross section of cup 100 having interior surface 110 and exterior surface 120 before any coating has been applied. The portion of cup 100 as shown in this example could be any cellulose substrate for any suitable article for which the biodegradable coating is desired. FIG. 4B illustrates applicator 450 applying starch dispersion 50 to a first surface (e.g., interior surface 110). FIG. 4C illustrates cup 100 after starch dispersion 50 has been applied to the first surface (e.g., interior surface 110) to form coating 111. FIG. 4D illustrates the optional step of applying starch dispersion 50 to a second surface opposite the first surface (e.g., exterior surface 120) using applicator 452. Applicator 452 may be the same as applicator 450. Starch dispersion 50 may be applied to both interior surface 110 and exterior surface 120 simultaneously or sequentially. Starch dispersion 50 may be applied to only one of the interior surface 110 or exterior surface 120. FIG. 4E illustrates cup 100 after starch dispersion 50 has been applied to exterior surface 120 to form coating 121.

The coating may be applied to both the interior or exterior surfaces using the exemplary process illustrated by FIGS. 4A to 4E. The coating may be applied only to an interior surface using the exemplary process illustrated by FIGS. 4A to 4C and skipping the steps illustrated in FIGS. 4D and 4E. The coating may be applied only to an exterior surface using the exemplary process illustrated by FIGS. 4A, 4D, and 4E, and skipping the steps illustrated in FIGS. 4B and 4C.

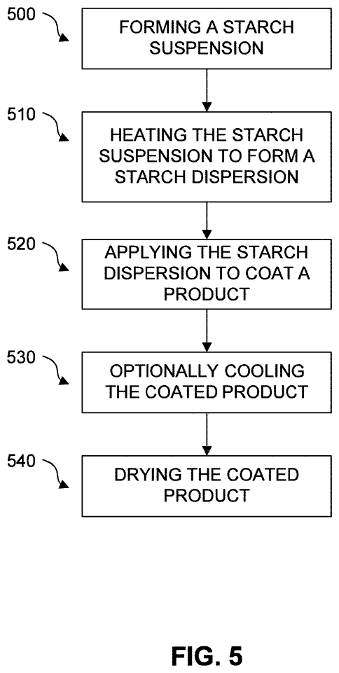

FIG. 5 shows a flow chart of an exemplary process for making a cellulose-based food or beverage container that is resistant to oil and grease in the presence of water. In some embodiments, at step 500 a native starch is mixed with water to form an aqueous suspension, at step 510 the aqueous suspension is heated to form a gelatinized stable starch dispersion (e.g., starch dispersion 50), at step 520 the starch dispersion is applied to a cellulose-based food or beverage article (e.g., cup 100, bowl 200, clamshell 300) for form a coating, at step 530 the coated cellulose-based food or beverage article is cooled, and at step 540 the coated cellulose-based food or beverage article is dried.

In some embodiments, at step 500 a native starch is mixed with water to form an aqueous starch suspension. In some embodiments, the starch is mixed under high shear conditions, which can improve application of higher viscosity dispersions. In some embodiments, the starch has an amylose content of at least 20% by weight (e.g., 20% by weight to 100% by weight, 20% by weight to 70% by weight, 20% by weight to 50% by weight, or 30% by weight to 50% by weight). In some embodiments, a starch having less than about 50% by weight amylose content (e.g., 30% by weight to 50% by weight amylose content) is used to make the aqueous starch suspension. In some embodiments, the starch has an amylose content of 30% by weight to 50% by weight.

In some embodiments, the concentration of the starch in the aqueous starch suspension is greater than or equal to 0.1% to less than or equal to 30%, greater than or equal to 0.5% to less than or equal to 25%, greater than or equal to 1% to less than or equal to 20%, greater than or equal to 2% to less than or equal to 15%, greater than or equal to 4% to less than or equal to 12%, greater than or equal to 5% to less than or equal to 10%, and all ranges and sub-ranges between the foregoing values having any two of the above-listed temperature values as endpoints, including the endpoints. In some embodiments, the concentration of the starch in the aqueous starch suspension is between 3% and 15%. In some embodiments, the concentration of the starch in the aqueous starch suspension is between 4% and 12%.

In some embodiments, at step 510 the aqueous starch suspension may be heated to a temperature of 80° C. to 160° C. to form a starch dispersion (e.g., starch dispersion 50). In some embodiments, the starch dispersion may be heated to a temperature greater than or equal to 80° C. to less than or equal to 120° C., greater than or equal to 85° C. to less than or equal to 115° C., greater than or equal to 90° C. to less than or equal to 110° C., greater than or equal to 95° C. to less than or equal to 105° C., greater than or equal to 95° C. to less than or equal to 100° C., and all ranges and sub-ranges between the foregoing values having any two of the above-listed temperature values as endpoints, including the endpoints. In some embodiments, the aqueous starch suspension is heated to between 140° C. to 160° C. In some embodiments, the aqueous starch suspension is heated to between 80° C. and 120° C. In some embodiments, the aqueous starch suspension is heated to between 80° C. and 100° C. to form a starch dispersion. In some embodiments, the starch suspension is heated for 1 minute to 30 minutes.

The aqueous starch suspension may be heated using a hot plate, steam heat, convection heat, or microwave. The aqueous starch suspension may be heated using a continuous cooker (e.g., steam jet-cookers or flow through heated tubes). Heating at low shear, atmospheric conditions may result in starch dispersions with relatively high viscosities and residual swollen and partially disrupted starch granules. The starch dispersion may also be heated under pressure in a pressure vessel, autoclave, or tube. In some embodiments, the starch dispersion is heated under atmospheric pressure (e.g., 1 atm). In some embodiments, the starch dispersion is heated at a pressure greater than atmospheric pressure (e.g., at least 2 atm, at least 3 atm, at least 4 atm, at least 5 atm, or at least 6 atm). The starch suspension may also be agitated at step 510. The agitation may be done by any suitable means (e.g., stirring, shaking, vibrating, or blending). High shear blending may be used to lower starch dispersion viscosity. Lowering starch dispersion viscosity may allow some of the starch coating to penetrate the cellulose-fiber matrix, which can protect the coating from abrasion (e.g., by utensils).

After heating, the starch dispersion may have a viscosity that allows the starch dispersion to be applied to the container (e.g., by pouring, brushing, spraying, or other suitable application means). Traditional paper coating methods using rollers and/or blades are not suitable for coating rigid or contoured objects like single-use cellulose-based containers (e.g., molded cups, plates, or clamshells) because they are not flat or as flexible as paper. The viscosity of the starch dispersion may be affected by heating temperature and heating times. Higher heating temperatures may correspond to lower viscosities. Longer heating times may correspond to lower viscosity. In some embodiments, the viscosity of the starch dispersion is between 10 centipoise and 10,000 centipoise. In some embodiments, the starch dispersion may have a viscosity greater than or equal to 10 centipoise to less than or equal to 10,000 centipoise, greater than or equal to 20 centipoise to less than or equal to 7500 centipoise, greater than or equal to 30 centipoise to less than or equal to 5000 centipoise, greater than or equal to 40 centipoise to less than or equal to 2000 centipoise, greater than or equal to 50 centipoise to less than or equal to 1000 centipoise, greater than or equal to 75 centipoise to less than or equal to 750 centipoise, greater than or equal to 100 centipoise to less than or equal to 600 centipoise, greater than or equal to 200 centipoise to less than or equal to 400 centipoise, and all ranges and sub-ranges between the foregoing values having any two of the above-listed temperature values as endpoints, including the endpoints. In some embodiments, the viscosity of the heated dispersion is between 10 centipoise and 2000 centipoise. In some embodiments, the viscosity of the heated dispersion is between 100 centipoise and 600 centipoise. In some embodiments the starch may have a viscosity between 1000 centipoise and 10,000 centipoise, which may allow the starch dispersion to be sprayed (e.g., by an air-brush type sprayer or an airless pressurized sprayer), dip coated or brushed. Plasticizers, such as glycerol, sorbitol or other sugars, glycerol esters, and citric acid esters, can be added to reduce viscosity of the coating dispersion and/or increase flexibility of finished dried coating. Plasticizers may reduce water stability of the finished dried coating. Thus, the amount of plasticizer used can be tailored for desired performance characteristics.

In some embodiments, the starch is a native starch. The starch may be lightly cooked.

In some embodiments, the starch dispersion is heated to a temperature sufficient to begin gelatinizing the starch. In some embodiments, this temperature is between 60° C. to 160° C. (e.g., between 80° C. and 100° C. or between 120° C. and 160° C.). In some embodiments, the starch dispersion is heated to about 90° C. Heating the starch to this temperature range improves the ability of the starch to bind to the surface of a cellulose-based food or beverage container.

Once prepared and at the appropriate viscosity, at step 520 the starch dispersion may be applied directly to cellulose-based food or beverage packaging (e.g., cup 100, bowl 200, or clamshell 300). The starch dispersion may be applied using an applicator (e.g., applicators 450 and 452). In some embodiments, applicator 450 applies the starch dispersion by brushing, dipping, spraying, curtain coating, or film extrusion. In some embodiments, the starch dispersion 50 is applied using applicator 450 to food or beverage contacting surface (e.g., interior surfaces 110, 210, or 310) of a cellulose-based food or beverage container (e.g., cup 100, bowl 200, or clamshell 300). In some embodiments, starch dispersion 50 is applied using applicator 452 an exterior surface (e.g., exterior surfaces 120, 220, or 320) of a cellulose-based food or beverage container (e.g., cup 100, bowl 200, or clamshell 300). In some embodiments, applicators 450 and 452 are sprayers. Spraying allows for a high-volume, continuous application process and precise application without significant waste. In some embodiments, the starch dispersion is sprayed onto the cellulose-based food and beverage packaging.

The starch dispersion may be applied at elevated temperatures, which reduces or prevents gelling and clogging in the sprayer. For example, the starch dispersion may be applied at a temperature between 30° C. to 100° C. In some embodiments, the starch dispersion may be applied at a temperature greater than or equal to 30° C. to less than or equal to 100° C., greater than or equal to 40° C. to less than or equal to 95° C., greater than or equal to 50° C. to less than or equal to 90° C., greater than or equal to 55° C. to less than or equal to 85° C., greater than or equal to 60° C. to less than or equal to 80° C., greater than or equal to 65° C. to less than or equal to 75° C., and all ranges and sub-ranges between the foregoing values having any two of the above-listed temperature values as endpoints, including the endpoints. In some embodiments, the starch dispersion is applied at a temperature of 60° C. to 80° C.

The starch dispersion may be coated in an amount sufficient to produce a dried coat weight of about 0.1% to about 30% (e.g., about 0.3% to about 15%, about 1% to about 15%, or about 1% to about 5%) of the weight of the cellulose-based food or beverage article. In some embodiments, the dried coat weight relative to the weight of the cellulose-based food or beverage article is greater than or equal to 0.3% to less than or equal to 15%, greater than or equal to 0.5% to less than or equal to 10%, or greater than or equal to 1% to less than or equal to 5%. In some embodiments the dried coat weight may be about 0.2 g/m² to about 150 g/m² (e.g., about 0.5 g/m² to about 90 g/m², about 3 g/m² to about 60 g/m², or about 5 g/m² or about 25 g/m²). In some embodiments, the dried coat weight may be greater than or equal to 1 g/m² to less than or equal to 90 g/m², greater than or equal to 2 g/m² to less than or equal to 70 g/m², greater than or equal to 3 g/m² to less than or equal to 50 g/m², greater than or equal to 4 g/m² to less than or equal to 40 g/m², greater than or equal to 5 g/m² to less than or equal to 30 g/m², greater than or equal to 5 g/m² to 25 g/m², greater than or equal to 5 g/m² to less than or equal to 10 g/m², and all ranges and sub-ranges between the foregoing values having any two of the above-listed dried coat weight values as endpoints, including the endpoints. In some embodiments, the dried coat weight may be 5 g/m² to 25 g/m².

After the starch coating is applied to the cellulose-based food or beverage packaging, at step 530 the coated packaging may optionally be cooled. For example, the coated packaging may be cooled at a temperature between 10° C. and 50° C. for 5 minutes or less. In some embodiments, the coated packaging may be cooled at a temperature greater than or equal to 10° C. to less than or equal to 50° C., greater than or equal to 15° C. to less than or equal to 45° C., greater than or equal to 20° C. to less than or equal to 40° C., greater than or equal to 20° C. to less than or equal to 35° C., greater than or equal to 20° C. to less than or equal to 30° C., or greater than or equal to 20° C. to less than or equal to 25° C. and all ranges and sub-ranges between the foregoing values having any two of the above-listed temperature values as endpoints, including the endpoints. In some embodiments, the coated packaging may be cooled at room temperature (e.g., about 20° C. to about 25° C.).

In some embodiments, the coated packaging may be cooled for a time greater than 0 minutes to less than or equal to 60 minutes, greater than or equal to 1 minutes to less than or equal to 10 minutes, greater than or equal to 1 minutes to less than or equal to 5 minutes, and all ranges and sub-ranges between the foregoing values having any two of the above-listed times as endpoints, including the endpoints. In some embodiments, the coated packaging may be cooled for 1 minute to 5 minutes. In some embodiments, the coated packaging is not cooled before the drying step (i.e., drying step 540 may begin after the coating is applied at step 520). Cooling times may depend on practical feasibility of processing conditions. For example, cooling time may be longer before drying if there is ample production space and time. Coated products may also be left at ambient temperature until the coating is completely dried with no need for a subsequent drying step.

After cooling, at step 540 (or after application at step 530 if the coated packaging is not cooled) the coated packaging may be dried at a temperature between 50° C. and 200° C. for between 1 minute and 60 minutes. In some embodiments, the coated packaging may be dried at a temperature greater than or equal to 50° C. to less than or equal to 180° C., greater than or equal to 60° C. to less than or equal to 170° C., greater than or equal to 70° C. to less than or equal to 160° C., greater than or equal to 80° C. to less than or equal to 150° C., greater than or equal to 90° C. to less than or equal to 140° C., greater than or equal to 100° C. to less than or equal to 130° C., or greater than or equal to 110° C. to less than or equal to 120° C., and all ranges and sub-ranges between the foregoing values having any two of the above-listed temperature values as endpoints, including the endpoints. In some embodiments, the coated packaging may be dried for a time greater than or equal to 1 minute to less than or equal to 60 minutes, greater than or equal to 5 minutes to less than or equal to 50 minutes, greater than or equal to 10 minutes to less than or equal to 40 minutes, greater than or equal to 20 minutes to less than or equal to 30 minutes, and all ranges and sub-ranges between the foregoing values having any two of the above-listed times as endpoints, including the endpoints. In some embodiments, the coated packaging may be dried at a temperature between 100° C. to 150° C. for 1 minute to 5 minutes. In some embodiments, the coated packaging may be dried at ambient temperature. Humidity may be optionally controlled in the drying chamber to between about 20% to about 80%, which can limit shrinkage of the starch coating and minimize possible tearing.

The coated packaging may be entirely biodegradable. In some embodiments, the coated packaging is biodegradable in less than 12 months (e.g., less than 9 months, less than 6 months, less than 3 months, less than 2 months, or less than 1 month). For example, in some embodiments, the coated packaging is entirely biodegradable in accordance with ASTM standards (e.g., D6400 for compositing or D6691 for marine biodegradation).

### EXAMPLES

Cellulose-fiber-based products used in the examples were made by pulp molding with a hot pressing such that the thickness of the cellulose-based products was about 0.5 mm and the density of the cellulose-based products was about 0.8 g/cm³.

### Example 1

In one experiment, a bleached cellulose-fiber-based plate was coated with a starch coating according to some embodiments, and the cellulose-fiber-based plate exhibited resistance to penetration by oil, grease, and moisture. The cellulose-fiber-based plate included about 0.4% by weight alkyl ketene dimer. Pea starch with an amylose content of about 35% by weight was used. Twenty (20) grams of pea starch was mixed with 200 milliliters of deionized water to form a suspension of 10% pea starch. The suspension was heated to boiling under stirring. The suspension was boiled for 2 to 3 minutes to create a viscous stable starch dispersion. The viscosity was such that the starch dispersion could be poured smoothly. The heated starch dispersion was then applied to the top side of a plate (i.e., the side that contacts the food). The plate measured 4 inches square and about 0.5 inches deep and weighed 6.3 grams.

Approximately 2 grams of the starch dispersion was applied to the plate by brushing on the starch dispersion, giving a dry coated weight of 0.2 grams, or about 3% of the weight of the plate. The coated plate was allowed to rest at room temperature (e.g., about 20° C. to about 25° C.) for 2 minutes. The coated plate was then dried in an oven at a temperature of 145° C. for 4 minutes. After drying, resistance to oil and grease penetration in the presence of water was tested by simulating exposure to moist, greasy food. First, 30 grams of boiling water was added to the finished dried coated plate. The boiling water was allowed to sit for 10 minutes. After pouring the water off, the plate was dried for about 5 seconds with a compressed air stream. Then about vegetable oil was dropped over the entire surface of the plate, spaced about 1.5 centimeters. With the vegetable oil still on the plate, oil penetration was monitored over a period of 1 hour to 24 hours. Although the starch coating slightly softened due to contact with the boiling water, the starch coating did not dissolve and remained adhered to the substrate and continuous for the full 24 hours. There were no visible signs that the grease or oil penetrated the coating, or that the water damaged the coating.

### Comparative Example 1

In another experiment, drops of vegetable oil were added to a plate having the same size, weight, and composition as the plate used in Example 1, but without the starch coating of Example 1. The oil drops placed on the uncoated fiber plate instantly caused circular stains to develop. The stains gradually darkened and expanded as the vegetable oil penetrated the substrate, and the drops were absorbed within minutes.

### Example 2

In another experiment, a suspension was formed by adding pea starch to water to form a suspension of 4% pea starch. The suspension was heated using a microwave. During heating, the suspension was shaken occasionally (e.g., every 5 seconds to 30 seconds) with decreasing frequency to prevent suspension settling, and the suspension was heated until boiling. The suspension was maintained at boiling in the microwave for 3 minutes to form a starch dispersion. The heated dispersion was applied by spraying the interior surface of the lower flat part of an unbleached cellulose-fiber-based bowls and a top side of a plate (i.e., the side that contacts the food) as used in Example 1 using an airbrush. The plate measured 4 inches square and about 0.5 inches deep, as described in Example 1. The bowls measured 9 inches by 5.6 inches and about 1.6 inches deep. The bowls each had a weight of about 20.5 grams. Both the plate and the bowl included about 0.4% by weight alkyl ketene dimer. The heated dispersion was applied at room temperature using an airbrush. The coated plate and bowl were allowed to rest at room temperature (e.g., about 20° C. to about 25° C.) for 2 minutes. The plate and bowl were then dried in an oven at a temperature of 145° C. for 4 minutes. The coating weight of the coated plate and bowl was about 2.6% by weight.

The plate was tested using the same procedure as Example 1 (i.e., boiling water was added followed by vegetable oil). The plate showed similar resistance to oil penetration as the plate in Example 1, with only slight oil stains at two corners of the square plate after 10 hours.

The bowls were tested with different types of foods to check whether any oils passed through the bowls by placing a napkin below the tested bowl to absorb any oil that passed through the bowl. First, a hot pasta with a tomato sauce was added to a first bowl. After 30 minutes, no residue was visible on the napkin beneath the first bowl, and no oil stain was evident in the bowl after the food was removed. Boiling water was added to a second bowl to a depth of about 1 inch. The boiling water was allowed to sit for 30 minutes. The water was then removed and the bowl was dried for about 30 seconds with a compressed air stream. Then pure vegetable oil was added to the second bowl. After 30 minutes, no residue was visible on the napkin beneath the second bowl. There were only about 3 scattered, slight oil stains in the bowl (i.e., stains about 0.1 cm² to about 5 cm²). Hot macaroni and cheese was added to a third bowl. After 30 minutes, no residue was visible on the napkin beneath the third bowl, and no oil stain was evident in the bowl after the food was removed.

### Comparative Example 2A

In another experiment, several drops of vegetable oil were added to a bowl having the same size, weight, and composition as the bowls used in Example 2, but without the starch coating of Example 2. The oil drops placed on the uncoated bowl were rapidly absorbed by the substrate and caused clear circular stains to develop within minutes as the vegetable oil penetrated the substrate. The stains gradually darkened and expanded as the vegetable oil penetrated the substrate. The vegetable oil was fully absorbed within about 3 minutes.

### Comparative Example 2B

A commercial-grade starch solution (e.g., RediFILM™ 5400) for paper sizing and coating was tested according to the method of Example 2. The commercial-grade starch solution included a solids content of about 25% to 27% by weight. The commercial-grade starch solution was applied to plates having the same size, weight, and composition as the plate used in Example 2. The commercial-grade starch solution was applied by spraying and tested as in Example 2, except that the solution was not heated before spraying as its viscosity was low enough. The coated plate was resistant to oil penetration in the dry state, i.e., without prior water treatment. But, the coating was nearly completely destroyed within a few minutes of contact with cold water. This resulted in loss of all oil resistance properties, and the oil test result was comparable to that of the uncoated plate in Comparative Example 1.

### Example 3

In another experiment, 4-inch square fiber plates having the same size, weight, and composition as the plate used in Example 1 were dip coated with a heated dispersion prepared according to Example 2. Thus, the heated dispersion was dip coated to both sides of the plates (e.g., the side that contacts food and the side that does not contact food) to form a dried coat weight total of about 2% by weight. Oil heated to a temperature of 87° C. was added in drops to the coated plate and allowed to sit for 30 minutes. No oil stain was visible.

### Example 4

In another experiment, a coated plate having the same size, weight, and composition as the plate used in Example 1 was prepared using the same procedures as Example 3, but while the heated oil was in the tray, a fork was used to scrape the surface of the plate contacting the oil. Although some of the coating was scraped off by the fork, no oil stain was visible.

### Example 5

In another experiment, 30 grams of corn starch having about 25% amylose content was added to 300 grams of water to form a suspension. The suspension was heated to boiling with stirring for 3 minutes, which produced a viscous dispersion. The heated dispersion was applied by brushing on to a plate having the same size, weight, and composition as the plate used in Example 1. About 2 grams of the heated dispersion was brushed onto the plate's inside surface, which resulted in about 3% by weight dry coating. The coated plate was allowed to rest at room temperature (e.g., about 20° C. to about 25° C.) for 3 minutes. The coated plate was then dried in an oven at a temperature of 145° C. for 4 minutes.

The coated plate was tested by first adding 30 grams of boiling water to the tray and letting the boiling water sit on the tray for 15 minutes. The water was then poured off the tray and the tray was dried with a compressed air steam for a few seconds. The coating was slightly softened but remained intact. Then oil was dropped onto the plate. Very minimal oil stain was observed only after about 1 to 3 hours.

### Comparative Example 5

In another experiment, the same procedure and testing as Example 5 was carried out, but the corn starch was substituted with waxy maize starch having about 1% amylose content. After heating, the starch dispersion formed a gel-like paste that was difficult to apply to the plate. After application by brush coating and drying, hot water was added to the plate. Upon water contact, the coating became slimy and separated from the substrate. For example, the coating could be removed by gently smearing or running a finger over the surface. After the water was removed, and when oil was applied, oil stains formed instantly and rapidly expanded, similar to Comparative Example 1.

### Example 6

In another experiment, 100 grams of corn starch having an amylose content of about 70% in 700 mL of water was cooked for 30 minutes in a Paar reactor until reaching 137° C. The heated dispersion was then cooled for 1 hour to 95° C. This formed a light yellow, low-viscosity dispersion. The dispersion was then diluted by ½ with boiling water. A plate having the same size, weight, and composition as the plate used in Example 1 was dip coated in the diluted dispersion to add about 3 grams of the diluted dispersion. This provided in total about a 3% by weight dry coating. The coated tray was allowed to rest at room temperature (e.g., about 20° C. to about 25° C.) for 2 minutes. The coated tray was then dried at a temperature of 145° C. for 4 minutes. Then 30 milliliters of boiling water was added and allowed to sit for 30 minutes. The water was poured off and oil was added. A minimal amount of oil stain at the inner surface was visible.

As used herein, “native starch” may refer to any unmodified starch in its native form. Native starch may include unmodified starches from a single source (e.g., pea starch, bean starch, etc.) or a blend of two different unmodified starches.

As used herein, when the term “about” is used in describing a value or an end-point of a range, the disclosure should be understood to include the specific value or end-point referred to. Whether or not a numerical value or end-point of a range recites “about,” the numerical value or end-point is intended to include two embodiments: one modified by “about,” and one not modified by “about.” As used herein, the term “about” may include ±10%.

Although certain embodiments disclose cellulose-based containers, it is to be understood that any suitable cellulose-based product (e.g., sheets, paper, paperboard, trays, etc.) may be coated using the compositions and methods disclosed herein.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A container for a food or a beverage comprising:
a substrate, the substrate comprising at least 30% cellulose;
a biodegradable coating on the substrate on a first surface of the container, wherein the coating comprises a starch, and wherein the starch comprises at least 20% by weight amylose,
wherein the coating is resistant to penetration by oil and grease in the presence of water for at least 1 hour.

2. The container of claim 1, wherein the starch comprises at least 30% by weight amylose and less than 50% by weight amylose.

3. The container of claim 1, wherein the container is a single-use container.

4. The container of claim 1, wherein the container is compostable.

5. The container of claim 1, wherein the first surface is an interior of the container, and wherein the coating forms a continuous layer on the interior of the container.

6. The container of claim 5, further comprising a starch coating on the substrate on a second surface of the container, wherein the second surface is an exterior of the container, wherein the starch coating on the exterior of the container has the same composition as the starch coating on the interior of the container.

7. The container of claim 1, wherein the starch is an unmodified starch.

8. The container of claim 7, wherein the starch comprises at least one of pea starch, bean starch, high amylose corn starch, high amylose wheat starch, high amylose potato starch, or high amylose barley starch.

9. The container of claim 1, wherein the cellulose is derived from at least one of wheat straw, sugarcane bagasse, bamboo hardwoods, softwoods, corn stalk, flax, hemp, jute, rice straw, switchgrass, reed grass, or miscanthus.

10. The container of claim 9, wherein the cellulose comprises alkyl ketene dimer, and wherein the alkyl ketene dimer is present in an amount of greater than 0% by weight and less than or equal to 1% by weight.

11. The container of claim 1, wherein the coating has a dried coat weight of about 1% to about 15% of a weight of the substrate.

12. The container of claim 1, wherein the coating has a dried coat weight of about 3 g/m² to 60 g/m².

13. A method of preparing a coated container for a food or beverage, the method comprising:
applying an aqueous dispersion to a first surface of a container to form a biodegradable coating, wherein the container comprises at least 30% cellulose, wherein the aqueous dispersion comprises a starch, and wherein the starch comprises at least 20% by weight amylose; and
drying the coated container at a temperature of 80° C. to 200° C.,
wherein the coating is resistant to penetration by oil and grease in the presence of water.

14. The method of claim 13, wherein the starch comprises at least 30% by weight amylose and less than 50% by weight amylose.

15. The method of claim 14, further comprising:
cooling the coated container at a temperature of 10° C. to 50° C. for 1 minute to 10 minutes before drying.

16. The method of claim 15, wherein the cooling is done at a temperature of 20° C. to 30° C., and wherein the drying is done at a temperature of 100° C. to 150° C.

17. The method of claim 16, wherein the drying is done for 1 minute to 60 minutes.

18. The method of claim 13, wherein the first surface is an interior of the container.

19. The method of claim 13, wherein the first surface is an exterior of the container.

20. The method of claim 13, further comprising molding the substrate to form the container.

21. A method of preparing a coating for a single-use food or beverage container, the method comprising:
mixing a starch having at least 20% by weight amylose with water to form a suspension;
heating the suspension to a temperature of at least 60° C.; and
stirring the suspension,
wherein the heating and stirring are each continuous for a period of time to produce the coating, and
wherein the coating has a viscosity of 10 centipoise and 10,000 centipoise,
wherein the coating is resistant to penetration by oil and grease in the presence of water.

22. The method of claim 21, wherein the starch has an amylose content of 30% by weight to 50% by weight.

23. The method of claim 22, wherein the temperature is between 60° C. and 160° C.

24. The method of claim 21, wherein the starch as an amylose content of greater than 50% by weight.

25. The method of claim 24, wherein the temperature is between 120° C. and 160° C.

26. The method of claim 21, wherein the heating occurs simultaneously with the stirring.

27. The method of claim 21, wherein the coating has a viscosity of 1000 centipoise to 10,000 centipoise.

28. The method of claim 21, further comprising applying the coating to the container.

29. The method of claim 28, wherein the coating is applied only to a first surface of the container, wherein the first surface is one of an interior of the container or an exterior of the container.
